(19) United States
(12) Patent Application Publication
(10) Pub. No.: US 2025/0056440 A1
(43) Pub. Date: Feb. 13, 2025

(54) SIDELINK SYNCHRONIZATION SIGNAL BLOCK COMMUNICATION

(71) Applicant: QUALCOMM Incorporated, San Diego, CA (US)

(72) Inventors: Chih-Hao LIU, San Diego, CA (US); Gabi SARKIS, San Diego, CA (US); Giovanni CHISCI, San Diego, CA (US); Jing SUN, San Diego, CA (US); Xiaoxia ZHANG, San Diego, CA (US); Jae Ho RYU, San Diego, CA (US)

(21) Appl. No.: 18/448,114

(22) Filed: Aug. 10, 2023

(51) Int. Cl. H04W 56/00

(52) U.S. Cl. CPC H04W 56/0015

(57) ABSTRACT

Various aspects of the present disclosure generally relate to wireless communication. In some aspects, a transmitting user equipment (UE) may obtain an indication of a sidelink synchronization signal block (SSB) candidate index associated with a sidelink SSB transmission. The UE may transmit, to a receiving UE, the indication of the sidelink SSB candidate index, the indication of the sidelink SSB candidate index being included in a sidelink SSB. Numerous other aspects are described.

### FIELD OF THE DISCLOSURE

Aspects of the present disclosure generally relate to wireless communication and to techniques and apparatuses for sidelink synchronization signal block communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitting user equipment (UE). The method may include obtaining an indication of a sidelink synchronization signal block (SSB) candidate index associated with a sidelink SSB transmission. The method may include transmitting, to a receiving UE, the indication of the sidelink SSB candidate index, the indication of the sidelink SSB candidate index being included in a sidelink SSB.

Some aspects described herein relate to a method of wireless communication performed by a receiving UE. The method may include receiving, from a transmitting UE, a sidelink SSB that includes an indication of a sidelink SSB candidate index. The method may include decoding the sidelink SSB candidate index in accordance with receiving the sidelink SSB that includes the indication of the sidelink SSB candidate index.

Some aspects described herein relate to a method of wireless communication performed by a receiving UE. The method may include obtaining configuration information associated with sidelink SSB monitoring, the configuration information indicating a quantity of sidelink SSBs to be monitored by the receiving UE in accordance with a sidelink SSB monitoring capability of the receiving UE. The method may include monitoring the quantity of sidelink SSBs in accordance with the configuration information and in accordance with the sidelink SSB monitoring capability of the receiving UE.

Some aspects described herein relate to a method of wireless communication performed by a transmitting UE. The method may include obtaining configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE. The method may include transmitting a quantity of sidelink SSBs in the one or more sidelink SSB candidates in accordance with the configuration information and in accordance with the sidelink SSB transmission capability of the transmitting UE.

Some aspects described herein relate to a transmitting UE for wireless communication. The transmitting UE may include one or more memories and one or more processors coupled to the one or more memories. The one or more processors may be configured to obtain an indication of a sidelink SSB candidate index associated with a sidelink SSB transmission. The one or more processors may be configured to transmit, to a receiving UE, the indication of the sidelink SSB candidate index, the indication of the sidelink SSB candidate index being included in a sidelink SSB.

Some aspects described herein relate to a receiving UE for wireless communication. The receiving UE may include one or more memories and one or more processors coupled to the one or more memories. The one or more processors may be configured to receive, from a transmitting UE, a sidelink SSB that includes an indication of a sidelink SSB candidate index. The one or more processors may be configured to decode the sidelink SSB candidate index in accordance with receiving the sidelink SSB that includes the indication of the sidelink SSB candidate index.

Some aspects described herein relate to a receiving UE for wireless communication. The receiving UE may include one or more memories and one or more processors coupled to the one or more memories. The one or more processors may be configured to obtain configuration information associated with sidelink SSB monitoring, the configuration information indicating a quantity of sidelink SSBs to be monitored by the receiving UE in accordance with a sidelink SSB monitoring capability of the receiving UE. The one or more processors may be configured to monitor the quantity of sidelink SSBs in accordance with the configuration information and in accordance with the sidelink SSB monitoring capability of the receiving UE.

Some aspects described herein relate to a transmitting UE for wireless communication. The transmitting UE may include one or more memories and one or more processors coupled to the one or more memories. The one or more processors may be configured to obtain configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE. The one or more processors may be configured to transmit a quantity of sidelink SSBs in the one or more sidelink SSB candidates in accordance with the configuration information and in accordance with the sidelink SSB transmission capability of the transmitting UE.

Some aspects described herein relate to a non-transitory computer-readable medium that stores a set of instructions for wireless communication by a transmitting UE. The set of instructions, when executed by one or more processors of the UE, may cause the UE to obtain an indication of a sidelink SSB candidate index associated with a sidelink SSB transmission. The set of instructions, when executed by one or more processors of the UE, may cause the UE to transmit, to a receiving UE, the indication of the sidelink SSB candidate index, the indication of the sidelink SSB candidate index being included in a sidelink SSB.

Some aspects described herein relate to a non-transitory computer-readable medium that stores a set of instructions for wireless communication by a receiving UE. The set of instructions, when executed by one or more processors of the UE, may cause the UE to receive, from a transmitting UE, a sidelink SSB that includes an indication of a sidelink SSB candidate index. The set of instructions, when executed by one or more processors of the UE, may cause the UE to decode the sidelink SSB candidate index in accordance with receiving the sidelink SSB that includes the indication of the sidelink SSB candidate index.

Some aspects described herein relate to a non-transitory computer-readable medium that stores a set of instructions for wireless communication by a UE. The set of instructions, when executed by one or more processors of the UE, may cause the UE to obtain configuration information associated with sidelink SSB monitoring, the configuration information indicating a quantity of sidelink SSBs to be monitored by the receiving UE in accordance with a sidelink SSB monitoring capability of the receiving UE. The set of instructions, when executed by one or more processors of the UE, may cause the UE to monitor the quantity of sidelink SSBs in accordance with the configuration information and in accordance with the sidelink SSB monitoring capability of the receiving UE.

Some aspects described herein relate to a non-transitory computer-readable medium that stores a set of instructions for wireless communication by a UE. The set of instructions, when executed by one or more processors of the UE, may cause the UE to obtain configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE. The set of instructions, when executed by one or more processors of the UE, may cause the UE to transmit a quantity of sidelink SSBs in the one or more sidelink SSB candidates in accordance with the configuration information and in accordance with the sidelink SSB transmission capability of the transmitting UE.

Some aspects described herein relate to an apparatus for wireless communication. The apparatus may include means for obtaining an indication of a sidelink SSB candidate index associated with a sidelink SSB transmission. The apparatus may include means for transmitting, to a receiving UE, the indication of the sidelink SSB candidate index, the indication of the sidelink SSB candidate index being included in a sidelink SSB.

Some aspects described herein relate to an apparatus for wireless communication. The apparatus may include means for receiving, from a transmitting UE, a sidelink SSB that includes an indication of a sidelink SSB candidate index. The apparatus may include means for decoding the sidelink SSB candidate index in accordance with receiving the sidelink SSB that includes the indication of the sidelink SSB candidate index.

Some aspects described herein relate to an apparatus for wireless communication. The apparatus may include means for obtaining configuration information associated with sidelink SSB monitoring, the configuration information indicating a quantity of sidelink SSBs to be monitored by the apparatus in accordance with a sidelink SSB monitoring capability of the apparatus. The apparatus may include means for monitoring the quantity of sidelink SSBs in accordance with the configuration information and in accordance with the sidelink SSB monitoring capability of the apparatus.

Some aspects described herein relate to an apparatus for wireless communication. The apparatus may include means for obtaining configuration information associated with a sidelink SSB transmission, the configuration information indicating one or more sidelink SSB candidates to be used by the apparatus for transmitting sidelink SSBs in accordance with a sidelink SSB transmission capability of the apparatus. The apparatus may include means for transmitting a quantity of sidelink SSBs in the one or more sidelink SSB candidates in accordance with the configuration information and in accordance with the sidelink SSB transmission capability of the apparatus.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a synchronization signal hierarchy, in accordance with the present disclosure.

FIG. 6 is a diagram illustrating an example of sidelink synchronization signal block (SSB) candidate index communication, in accordance with the present disclosure.

FIG. 7 is a diagram illustrating an example of sidelink SSB monitoring and transmission, in accordance with the present disclosure.

FIG. 8 is a diagram illustrating an example of sidelink SSB candidates, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a UE or an apparatus of a UE, in accordance with the present disclosure.

FIG. 13 is a diagram of an example apparatus for wireless communication, in accordance with the present disclosure.

### DETAILED DESCRIPTION

A synchronization signal block (SSB) may be used for synchronizing communications between two or more devices, and/or may be used for channel estimation and beamforming purposes, among other examples. In some cases, the SSB may be a sidelink SSB (S-SSB) that is transmitted by a transmitting user equipment (UE) to a receiving UE to synchronize the communications between the transmitting UE and the receiving UE. In some cases, the transmitting UE may attempt to transmit a sidelink SSB on a sidelink SSB occasion regardless of whether the sidelink SSB has been transmitted in one or more previous sidelink SSB transmission occasions (for example, in one or more legacy sidelink SSB transmission occasions, such as one or more sidelink SSB transmission occasions described in connection with Release 16 and/or Release 17 of the 3GPP specifications). In some cases, each legacy sidelink SSB slot may have K corresponding additional sidelink SSB candidate occasions that are located in different time slots, and a gap between the sidelink SSB candidate occasions may be configured (e.g., pre-configured). Sidelink SSB slots, including the legacy sidelink SSB slots and one or more additional sidelink SSB slots (such as sidelink SSB slots described in connection with Release 18 of the 3GPP specifications) may be excluded from a resource pool, and logical slots may be defined on the non-sidelink-SSB slots. Since the sidelink SSB transmitter UE may transmit in any of the candidate sidelink SSB slots (e.g., one or a subset of the candidate sidelink SSB slots), the initial synchronization receiving UE that receives the sidelink SSB may not be able to identify which sidelink SSB slots are to be excluded from the resource pool within a single sidelink SSB period. Additionally, a receiving UE may be able to identify a number of sidelink SSB candidate slots, and may be able to identify the gap between the sidelink SSB candidate slots. However, when detecting a sidelink SSB over-the-air (OTA), the receiving UE may not be able to map the sidelink SSB received from the transmitting UE to a sidelink SSB candidate slot, and/or may not be able to map a receiving sidelink SSB candidate grid to a transmitting sidelink SSB candidate grid. In one example, an SSB period may include a legacy sidelink SSB candidate slot (located at candidate 0) and multiple additional sidelink SSB candidate slots (located at candidate 1, candidate 2, and candidate 3, respectively). The receiving UE may receive a sidelink SSB, but may not be able to identify whether the sidelink SSB is to be mapped to candidate 0, candidate 1, candidate 2, or candidate 3. This may result in communications between the transmitting UE and the receiving UE not being synchronized, and may result, for example, in missed communications between the transmitting UE and the receiving UE.

Various aspects generally relate to sidelink SSB communications. In some aspects, a transmitting UE may obtain an indication of a sidelink SSB candidate index associated with a sidelink SSB transmission, and may transmit, to a receiving UE, the indication of the sidelink SSB candidate index. The indication of the sidelink SSB candidate index may be included, for example, in at least one of a physical sidelink broadcast channel (PSBCH) demodulation reference signal (DMRS) scrambling sequence of the sidelink SSB or in a PSBCH payload of the sidelink SSB. In some aspects, the receiving UE may receive, from the transmitting UE, the sidelink SSB that includes the indication of the sidelink SSB candidate index, and may decode the sidelink SSB candidate index in accordance with receiving the sidelink SSB that includes the indication of the sidelink SSB candidate index. Decoding the sidelink SSB candidate index may include, for example, identifying one or more sidelink SSB candidate slots in a time domain and/or configuring a resource pool that excludes the one or more sidelink SSB candidate slots. In some aspects, the receiving UE may be configured to obtain configuration information associated with SSB monitoring, the configuration information indicating a quantity of sidelink SSBs to be monitored by the receiving UE in accordance with a sidelink SSB monitoring capability of the receiving UE, and may monitor the quantity of sidelink SSBs in accordance with the configuration information and in accordance with the sidelink SSB monitoring capability of the receiving UE. Additionally, or alternatively, the transmitting UE may be configured to obtain configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE, and may transmit a quantity of sidelink SSBs in the one or more sidelink SSB candidates in accordance with the configuration information and in accordance with the sidelink SSB transmission capability of the transmitting UE.

Particular aspects of the subject matter described in this disclosure can be implemented to realize one or more of the following potential advantages. In some examples, by obtaining an indication of a sidelink SSB candidate index associated with a sidelink SSB transmission, the described techniques can be used to enable a transmitting UE to transmit an indication of a sidelink SSB candidate index via a sidelink SSB. This may improve a synchronization of communications between the transmitting UE and the receiving UE. Additionally, the receiving UE may be configured to decode the sidelink SSB candidate index received from the transmitting UE, which can be used to enable the receiving UE to identify one or more sidelink SSB candidate slots in a time domain and/or to configure a resource pool for an initial synchronization. In some examples, multiple classes of receiving UEs may be defined, and a receiving UE may be configured to monitor a subset of sidelink SSBs in accordance with a class of the receiving UE. Additionally, multiple classes of transmitting UEs may be defined, and a transmitting UE may be configured to transmit sidelink SSBs in a subset of sidelink SSB candidates in accordance with a class of the transmitting UE. This may improve a likelihood of successful SSB communication between the transmitting UE and the receiving UE. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

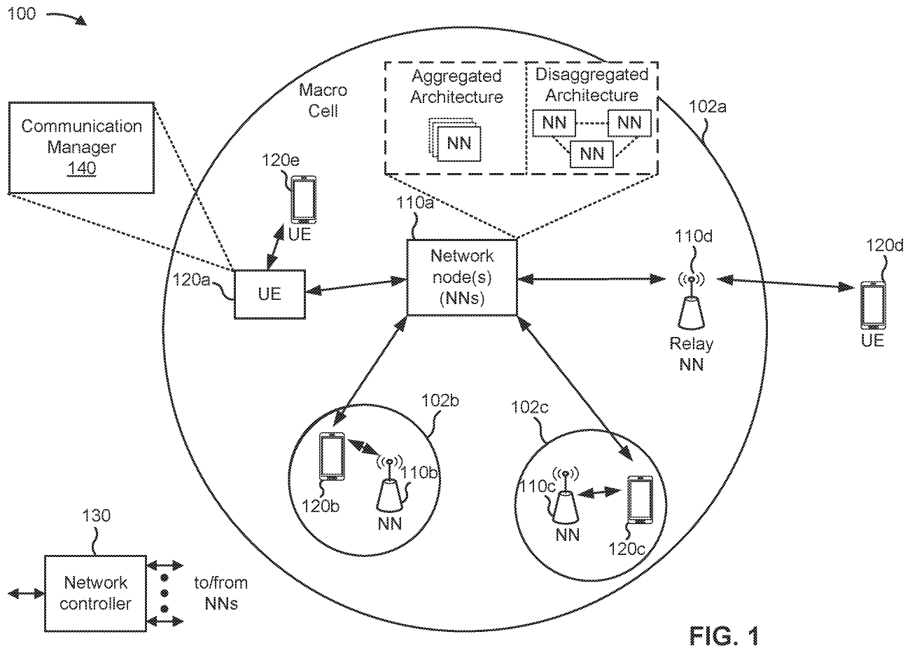

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. In some aspects, as described in more detail elsewhere herein, the communication manager 140 may obtain an indication of a sidelink SSB candidate index associated with a sidelink SSB transmission; and transmit, to a receiving UE, the indication of the sidelink SSB candidate index, the indication of the sidelink SSB candidate index being included in a sidelink SSB. In some other aspects, as described in more detail elsewhere herein, the communication manager 140 may receive, from a transmitting UE, a sidelink SSB that includes an indication of a sidelink SSB candidate index; and decode the sidelink SSB candidate index in accordance with receiving the sidelink SSB that includes the indication of the sidelink SSB candidate index. In some other aspects, as described in more detail elsewhere herein, the communication manager 140 may obtain configuration information associated with sidelink SSB monitoring, the configuration information indicating a quantity of sidelink SSBs to be monitored by the receiving UE in accordance with a sidelink SSB monitoring capability of the receiving UE; and monitor the quantity of sidelink SSBs in accordance with the configuration information and in accordance with the sidelink SSB monitoring capability of the receiving UE. In some other aspects, as described in more detail elsewhere herein, the communication manager 140 may obtain configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE; and transmit a quantity of sidelink SSBs in the one or more sidelink SSB candidates in accordance with the configuration information and in accordance with the sidelink SSB transmission capability of the transmitting UE. Additionally, or alternatively, the communication manager 140 may perform one or more other operations described herein.

As indicated above, FIG. 1 is provided as an example. Other examples may differ from what is described with regard to FIG. 1.

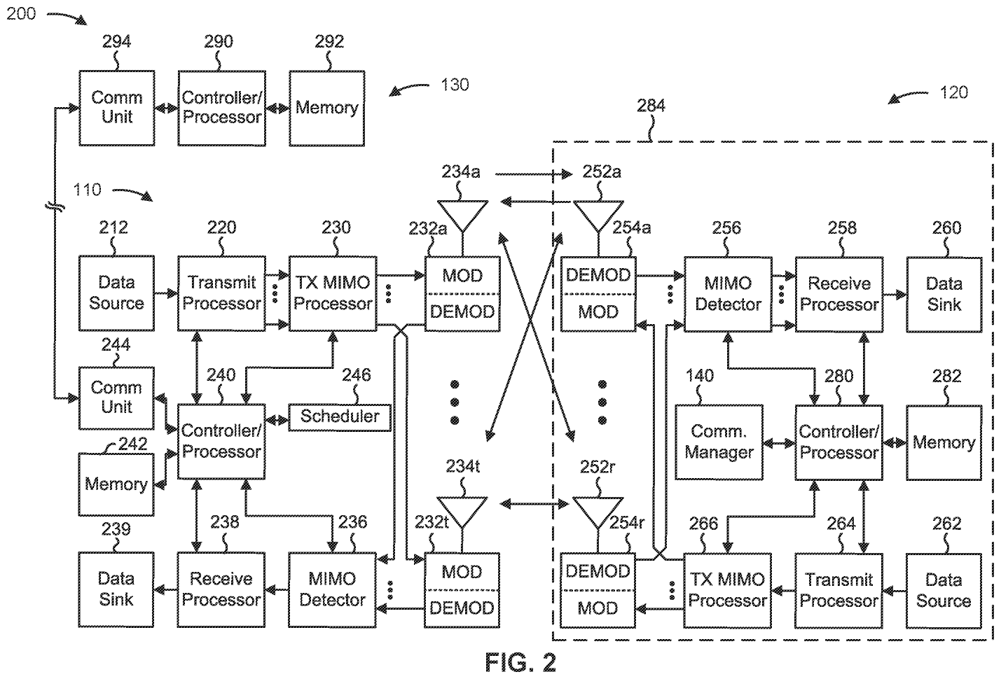

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a DMRS) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

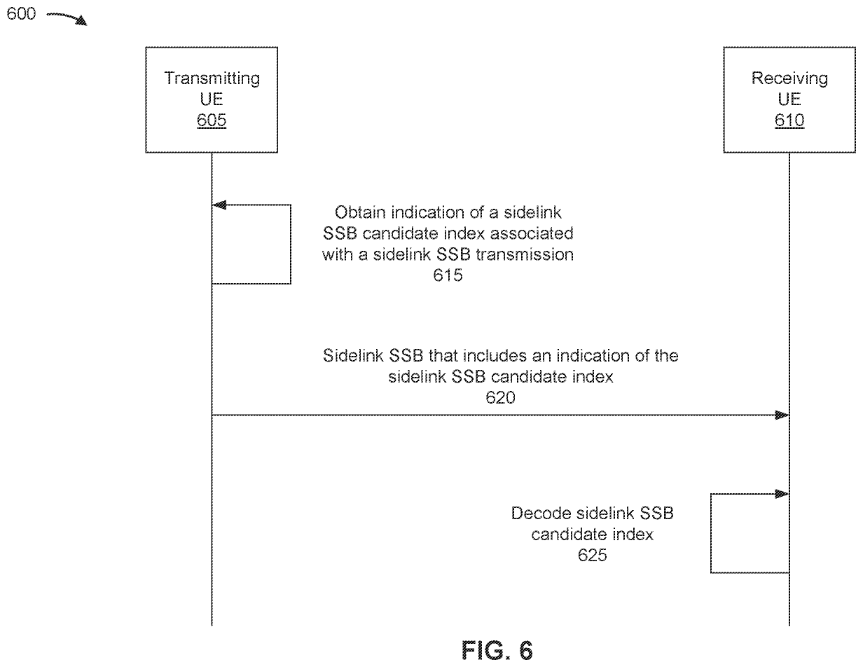

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

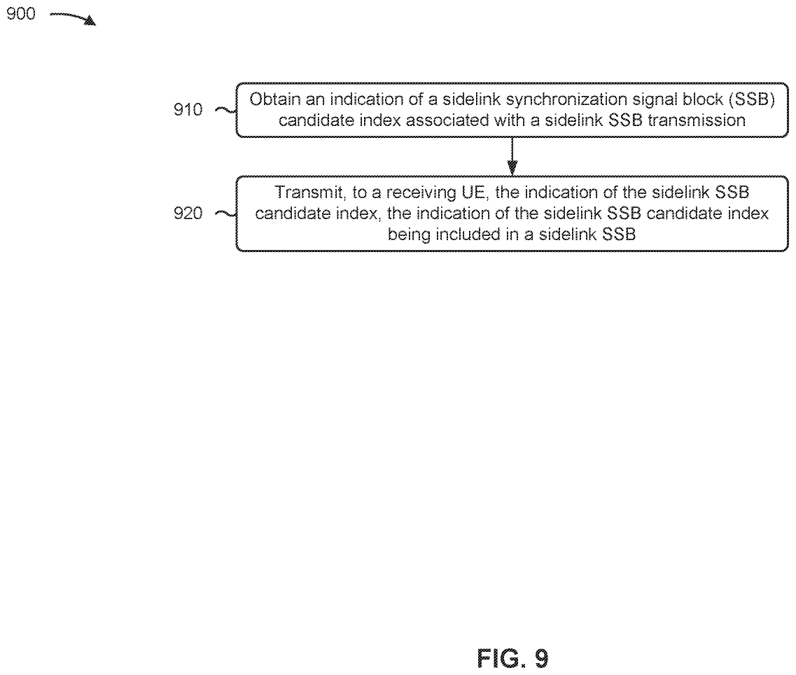

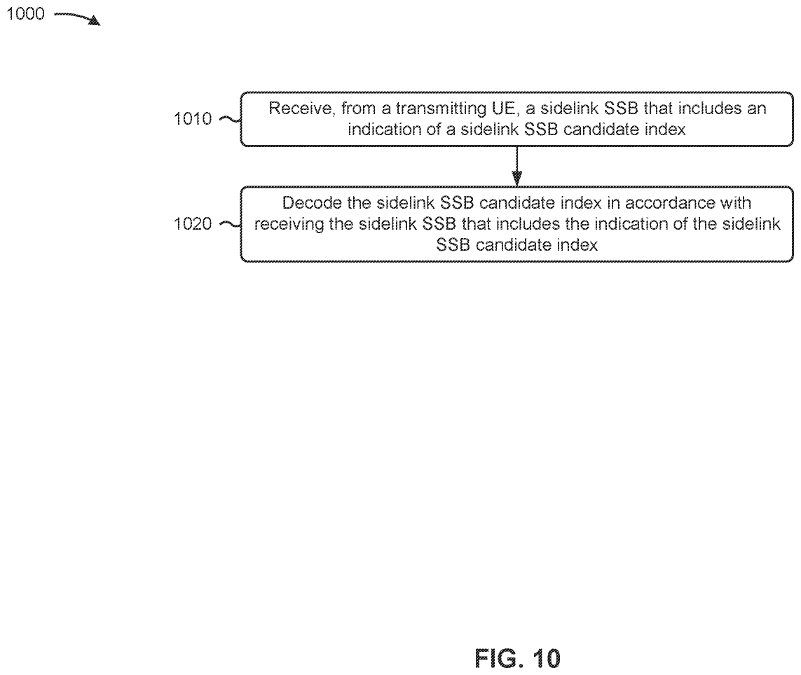

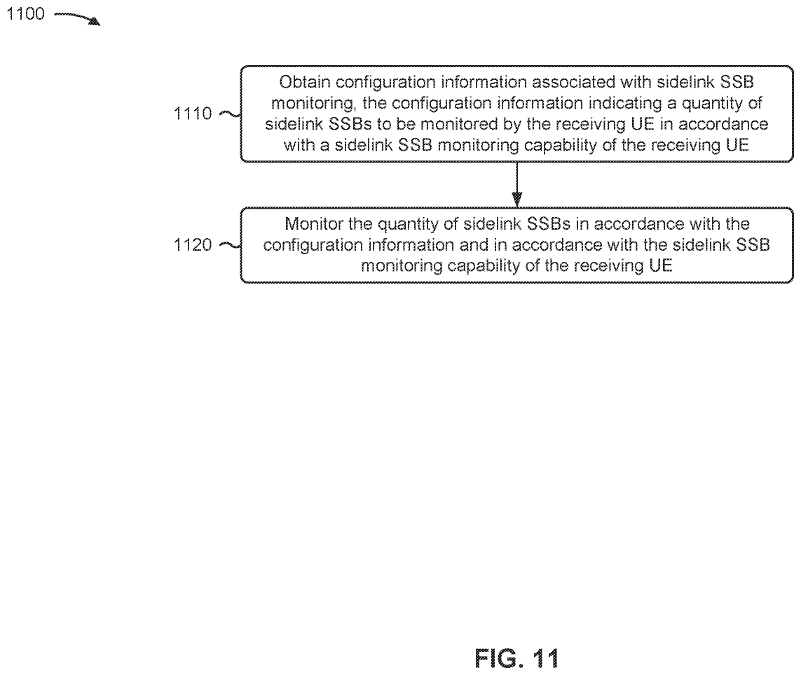

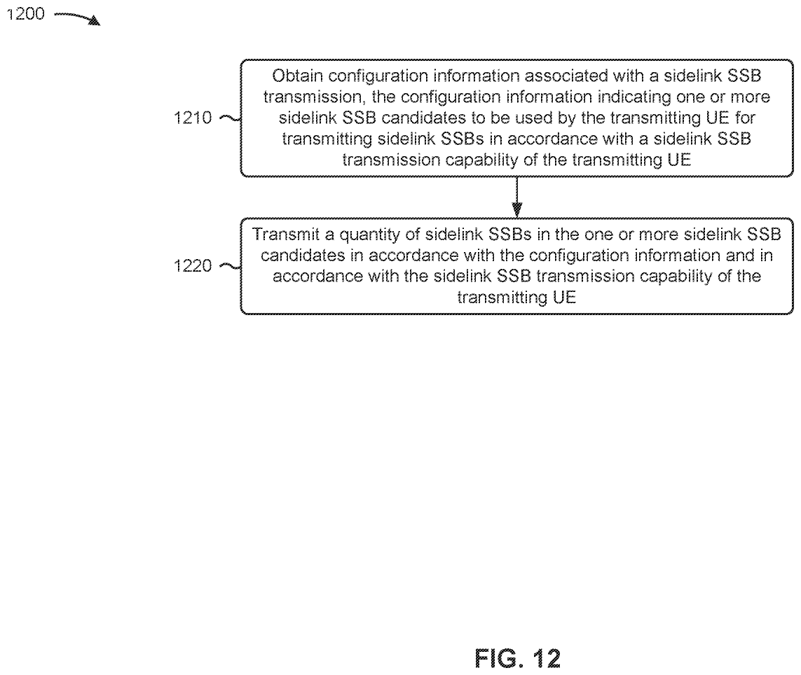

The controller/processor 240 of the network node 110, the controller/processor 280 of the UE 120, and/or any other component(s) of FIG. 2 may perform one or more techniques associated with sidelink SSB communication, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 (e.g., a transmitting UE) includes means for obtaining an indication of a sidelink SSB candidate index associated with a sidelink SSB transmission; and/or means for transmitting, to a receiving UE, the indication of the sidelink SSB candidate index, the indication of the sidelink SSB candidate index being included in a sidelink SSB. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 (e.g., a receiving UE) includes means for receiving, from a transmitting UE, a sidelink SSB that includes an indication of a sidelink SSB candidate index; and/or means for decoding the sidelink SSB candidate index in accordance with receiving the sidelink SSB that includes the indication of the sidelink SSB candidate index. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 (e.g., a receiving UE) includes means for obtaining configuration information associated with sidelink SSB monitoring, the configuration information indicating a quantity of sidelink SSBs to be monitored by the receiving UE in accordance with a sidelink SSB monitoring capability of the receiving UE; and/or means for monitoring the quantity of sidelink SSBs in accordance with the configuration information and in accordance with the sidelink SSB monitoring capability of the receiving UE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 (e.g., a transmitting UE) includes means for obtaining configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE; and/or means for transmitting a quantity of sidelink SSBs in the one or more sidelink SSB candidates in accordance with the configuration information and in accordance with the sidelink SSB transmission capability of the transmitting UE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

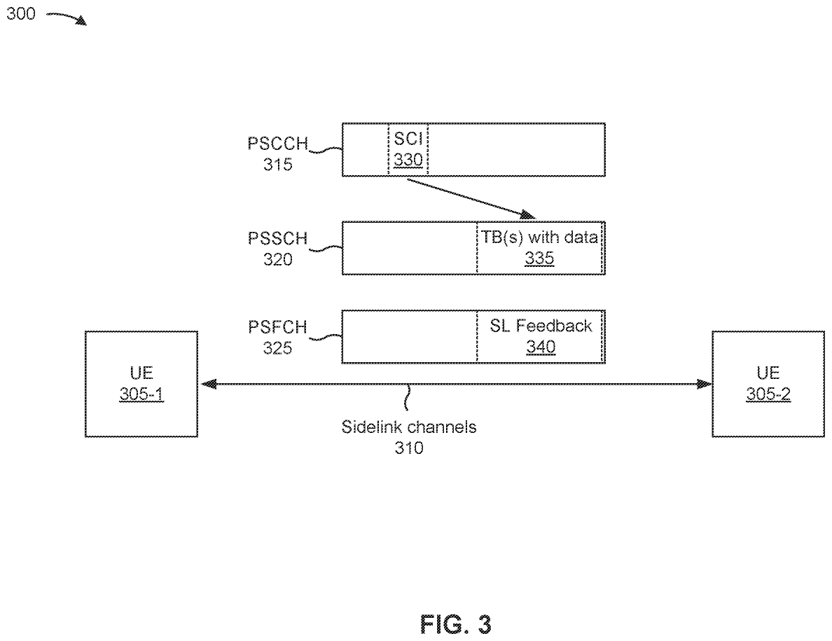

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

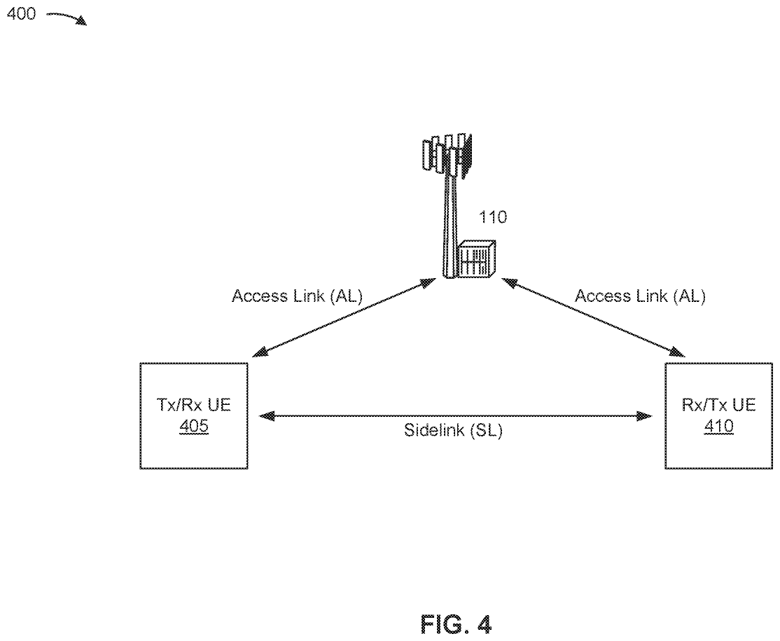

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

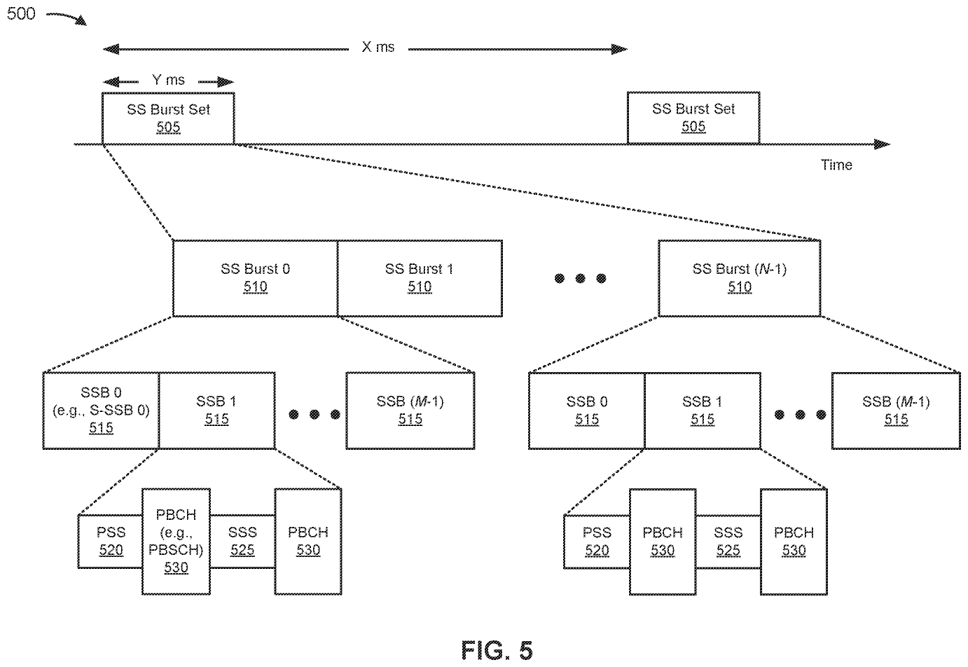

FIG. 5 is a diagram illustrating an example 500 of a synchronization signal (SS) hierarchy, in accordance with the present disclosure. As shown in FIG. 5, the SS hierarchy may include an SS burst set 505, which may include multiple SS bursts 510, shown as SS burst 0 through SS burst N-1, where N is a maximum number of repetitions of the SS burst 510 that may be transmitted by one or more network nodes. As further shown, each SS burst 510 may include one or more SSBs 515, shown as SSB 0 through SSB M-1, where M is a maximum number of SSBs 515 that can be carried by an SS burst 510. In some cases, an SSB may be a sidelink SSB (an S-SSB that is communicated between UEs, such as UE 305-1 and UE 305-2). In some cases, different SSBs 515 may be beam-formed differently (e.g., transmitted using different beams), and may be used for cell search, cell acquisition, beam management, and/or beam selection (e.g., as part of an initial network access procedure). An SS burst set 505 may be periodically transmitted by a wireless node (e.g., a network node 110), such as every X milliseconds, as shown in FIG. 5. In some cases, an SS burst set 505 may have a fixed or dynamic length, shown as Y milliseconds in FIG. 5. In some cases, an SS burst set 505 or an SS burst 510 may be referred to as a discovery reference signal (DRS) transmission window or an SSB measurement time configuration (SMTC) window.

In some cases, an SSB 515 may include resources that carry a primary synchronization signal (PSS) 520, a secondary synchronization signal (SSS) 525, and/or a physical broadcast channel (PBCH) 530. In some cases, the physical broadcast channel may be a physical sidelink broadcast channel (PSBCH) for communications between UEs (such as UE 305-1 and UE 305-2). In some cases, multiple SSBs 515 are included in an SS burst 510 (e.g., with transmission on different beams), and the PSS 520, the SSS 525, and/or the PBCH 530 may be the same across each SSB 515 of the SS burst 510. In some cases, a single SSB 515 may be included in an SS burst 510. In some cases, the SSB 515 may be at least four symbols (e.g., OFDM symbols) in length, where each symbol carries one or more of the PSS 520 (e.g., occupying one symbol), the SSS 525 (e.g., occupying one symbol), and/or the PBCH 530 (e.g., occupying two symbols). In some cases, an SSB 515 may be referred to as an SS/PBCH block.

In some cases, the symbols of an SSB 515 are consecutive, as shown in FIG. 5. In some cases, the symbols of an SSB 515 are non-consecutive. Similarly, in some cases, one or more SSBs 515 of the SS burst 510 may be transmitted in consecutive radio resources (e.g., consecutive symbols) during one or more slots. Additionally, or alternatively, one or more SSBs 515 of the SS burst 510 may be transmitted in non-consecutive radio resources.

In some cases, the SS bursts 510 may have a burst period, and the SSBs 515 of the SS burst 510 may be transmitted by a wireless node (e.g., a network node 110) according to the burst period. In this case, the SSBs 515 may be repeated during each SS burst 510. In some cases, the SS burst set 505 may have a burst set periodicity, whereby the SS bursts 510 of the SS burst set 505 are transmitted by the wireless node according to the fixed burst set periodicity. In other words, the SS bursts 510 may be repeated during each SS burst set 505.

In some cases, an SSB 515 may include an SSB index, which may correspond to a beam used to carry the SSB 515. A UE 120 may monitor for and/or measure SSBs 515 using different receive (Rx) beams during an initial network access procedure and/or a cell search procedure, among other examples. Based at least in part on the monitoring and/or measuring, the UE 120 may indicate one or more SSBs 515 with a best signal parameter (e.g., a reference signal received power (RSRP) parameter) to a network node 110 (e.g., directly or via one or more other network nodes). The network node 110 and the UE 120 may use the one or more indicated SSBs 515 to select one or more beams to be used for communication between the network node 110 and the UE 120 (e.g., for a random access channel (RACH) procedure). Additionally, or alternatively, the UE 120 may use the SSB 515 and/or the SSB index to determine a cell timing for a cell via which the SSB 515 is received (e.g., a serving cell).

As indicated above, FIG. 5 is provided as an example. Other examples may differ from what is described with regard to FIG. 5.

FIG. 6 is a diagram illustrating an example 600 of sidelink SSB candidate index communication, in accordance with the present disclosure. A transmitting UE 605 may communicate with a receiving UE 610. The transmitting UE 605 may include some or all of the features of the UE 120, the UE 305, the UE 405, or the UE 410. Additionally, the receiving UE 610 may include some or all of the features of the UE 120, the UE 305, the UE 405, or the UE 410.

As shown by reference number 615, the transmitting UE 605 may obtain an indication of a sidelink SSB candidate index associated with a sidelink SSB transmission. The sidelink SSB candidate index may be associated with a sidelink SSB slot number. For example, the sidelink SSB index may include an indication of a slot number associated with the sidelink SSB transmission.

As shown by reference number 620, the transmitting UE 605 may transmit, and the receiving UE 610 may receive, an indication of the sidelink SSB candidate index. For example, the transmitting UE 605 may transmit, and the receiving UE 610 may receive, a sidelink SSB that includes the indication of the sidelink SSB candidate index.

In a first example, the sidelink SSB candidate index may be included in a PSBCH DMRS scrambling sequence of the sidelink SSB. For example, by adding X DMRS scrambling attempts (e.g., hypotheses), the DMRS may be used to carry a quantity of bits to indicate the sidelink SSB candidate index. The quantity of bits used to indicate the sidelink SSB candidate index may be indicated by floor(log₂ X) bits. In one example, one, two, or three bits may be used to indicate one, four, or eight sidelink SSB candidate indexes, respectively. In some aspects,

$${C}_{init} = {2}^{11} ( {i}_{cand} + 1 ) ( ⌊ \frac{{N}_{ID}^{SL}}{4} ⌋ + 1 ) + {2}^{6} ( {i}_{cand} + 1 ) + ( {N}_{ID}^{SL} mod 4 )$$

$$for a candidate {i}_{cand} ,$$

where
Cᵢₙᵢₜ is an initial sidelink SSB candidate index,
i_{cand} is a select (e.g., a current) sidelink SSB candidate index, and
N_{ID}^{SL} is a sidelink identification number.

In some other aspects,

$${C}_{init} = {2}^{11} ( {i}_{cand} + 1 ) ( ⌊ \frac{{N}_{ID}^{SL}}{4} ⌋ + 1 ) + {2}^{6} ( {i}_{cand} + 1 ) + ( {N}_{ID}^{SL} mod 4 )$$

$$for a candidate {i}_{cand} ( {i}_{cand} > 0 ) ,$$

and
Cᵢₙᵢₜ=N_{ID}^{SL} for a candidate i_{cand} (i_{cand}=0)

In some aspects, a legacy sidelink SSB instance (e.g., candidate 0) may use a legacy DMRS scrambling sequence, while a later sidelink SSB transmitted in a subsequent candidate (e.g., candidate 1 or later) may use a candidate index that is based at least in part on a DMRS scrambling sequence. This may maintain the legacy sidelink SSB in the legacy sidelink SSB slot. In some aspects, a maximum number of sidelink SSB candidates in the PSBCH DMRS scrambling sequence may be less than or equal to eight (e.g., to align with a PBCH scrambling seed design).

In a second example, the sidelink SSB candidate index may be included in a PSBCH payload of the sidelink SSB. In some aspects, this may be more demanding for the sidelink SSB transmitting UE since the sidelink SSB transmitting UE may need to encode the PSBCH with different payloads for different PSBCH candidates. In contrast, in the first example described above, only the DMRS scrambling sequence may need to be changed.

In a third example, the sidelink SSB candidate index may be included in the PSBCH DMRS scrambling sequence of the sidelink SSB and in the PSBCH payload of the sidelink SSB. For example, a first portion of the sidelink SSB candidate index may be included in the PSBCH DMRS scrambling sequence of the sidelink SSB, and a second portion of the sidelink SSB candidate index may be included in the PSBCH payload of the sidelink SSB. This may be used, for example, when the number of sidelink SSB candidates is greater than eight. In one example, a first portion of the bits of the sidelink SSB candidate index (e.g., the first eight bits of the sidelink SSB candidate index) may be included in the PSBCH DMRS scrambling sequence of the sidelink SSB, and one or more additional bits (e.g., most significant bits) of the sidelink SSB index may be included in the PSBCH payload of the sidelink SSB.

As shown by reference number 625, the receiving UE 610 may decode the sidelink SSB candidate index. For example, the receiving UE 610 may receive the sidelink SSB from the transmitting UE 605 that includes the indication of the sidelink SSB candidate index, and may decode the sidelink SSB candidate index included in the sidelink SSB. In some aspects, the receiving UE 610 may identify one or more sidelink SSB candidate slots (in a time domain). Additionally, or alternatively, the receiving UE 610 may configure a resource pool that excludes the sidelink SSB slots. In some aspects, the receiving UE 610 may identify the sidelink SSB slots in accordance with information associated with the number of sidelink SSB candidates, a gap between the sidelink SSB candidates, a number of legacy sidelink SSB slots, and/or an offset within a single sidelink SSB period, and may exclude the identified sidelink SSB slots from the resource pool.

As indicated above, FIG. 6 is provided as an example. Other examples may differ from what is described with regard to FIG. 6.

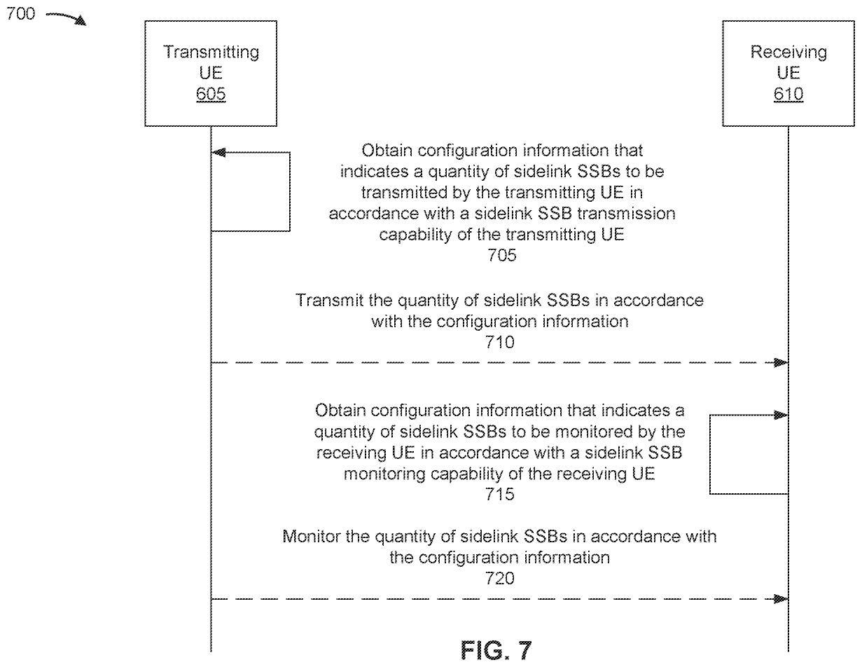

FIG. 7 is a diagram illustrating an example 700 of sidelink SSB monitoring and transmission, in accordance with the present disclosure.

As shown by reference number 705, the transmitting UE 605 may obtain configuration information associated with a sidelink SSB transmission. The configuration information may indicate one or more sidelink SSB candidates to be used by the transmitting UE 605 for transmitting sidelink SSBs. In some aspects, different classes of transmitting UEs may be configured to transmit sidelink SSBs in different subsets of sidelink SSB candidates. For example, a transmitting UE 605-1 may be configured to transmit sidelink SSBs in a subset of sidelink SSB candidates, and a transmitting UE 605-2 may be configured to transmit sidelink SSBs in another subset of sidelink SSB candidates. The other subset of sidelink SSB candidates may be larger than the subset of sidelink SSB candidates and/or may include the subset of sidelink SSB candidates. In some aspects, the transmitting UE 605-1 may be configured to transmit sidelink SSBs in the subset of sidelink SSB candidates in accordance with a capability and/or a complexity of the transmitting UE 605-1, and the transmitting UE 605-2 may be configured to transmit sidelink SSBs in the other subset of sidelink SSB candidates in accordance with a capability and/or a complexity of the transmitting UE 605-2.

In some aspects, three classes (e.g., types) of transmitting UEs may be defined for transmissions of sidelink SSBs in some or all of the sidelink SSB candidates. A first class of transmitting UE may be configured to transmit sidelink SSBs in a first sidelink SSB candidate, such as a legacy sidelink SSB candidate slot (e.g., candidate 0). The first class of transmitting UE may be configured to transmit sidelink SSBs only in the legacy sidelink SSB candidate slot in accordance with the first class of transmitting UE having a first capability (e.g., low capability) and/or a first complexity (e.g., low complexity). In this example, if a listen-before-talk (LBT) failure occurs, the first class of transmitting UE may be configured to wait until a next legacy sidelink SSB candidate slot (e.g., candidate 0) to perform a sidelink SSB transmission. A second class of transmitting UE may be configured to transmit sidelink SSBs in a subset of sidelink SSB candidates. The subset of sidelink SSB candidates may be greater than one and may be less than a total number of sidelink SSB candidates. For example, the second class of transmitting UE may be configured to transmit in the legacy sidelink SSB candidate slot and/or in one or more of (but less than all of) the additional sidelink SSB candidate slots. In one example, the second class of transmitting UE may be configured to transmit in two or more sidelink SSB candidates that begin at the legacy sidelink SSB candidate slot. The second class of transmitting UE may be configured to transmit sidelink SSBs in the subset of sidelink SSB candidates in accordance with the second class of transmitting UE having a second capability (e.g., medium capability) and/or a second complexity (e.g., medium complexity). A third class of transmitting UE may be configured to transmit sidelink SSBs in all sidelink SSB candidates. The third class of transmitting UE may be configured to transmit sidelink SSBs in all sidelink SSB candidates in accordance with the third class of transmitting UE having a third capability (e.g., high capability) and/or a third complexity (e.g., high complexity).

As shown by reference number 710, the transmitting UE 605 may transmit a quantity of sidelink SSBs in accordance with the capability information. For example, the transmitting UE 605 may transmit a sidelink SSB in a legacy sidelink SSB candidate in accordance with the transmitting UE 605 being included in the first class of transmitting UE. In another example, the transmitting UE 605 may transmit a plurality of sidelink SSBs in the subset of sidelink SSB candidates in accordance with the transmitting UE 605 being included in the second class of transmitting UE. In another example, the transmitting UE 605 may transmit a plurality of sidelink SSBs in all sidelink SSB candidates in accordance with the transmitting UE 605 being included in the third class of transmitting UE.

As shown by reference number 715, the receiving UE 610 may obtain configuration information associated with sidelink SSB monitoring. The configuration information may indicate a quantity of sidelink SSBs to be monitored by the receiving UE 610. In some aspects, different classes of receiving UEs may be configured to monitor sidelink SSBs in different subsets of sidelink SSB candidates. For example, a receiving UE 610-1 may be configured to monitor sidelink SSBs in a subset of sidelink SSB candidates, and a receiving UE 610-2 may be configured to monitor sidelink SSBs in another subset of sidelink SSB candidates. The other subset of sidelink SSB candidates may be larger than the subset of sidelink SSB candidates and/or may include the subset of sidelink SSB candidates. In some aspects, the receiving UE 610-1 may be configured to monitor sidelink SSBs in the subset of sidelink SSB candidates in accordance with a capability and/or a complexity of the receiving UE 610-1, and the receiving UE 610-2 may be configured to monitor sidelink SSBs in the other subset of sidelink SSB candidates in accordance with a capability and/or a complexity of the receiving UE 610-2.

In some aspects, three classes (e.g., types) of receiving UEs may be defined for monitoring sidelink SSBs in some or all of the sidelink SSB candidates. A first class of receiving UE may be configured to monitor sidelink SSBs in a first sidelink SSB candidate, such as a legacy sidelink SSB candidate slot (e.g., candidate 0). The first class of receiving UE may be configured to monitor sidelink SSBs only in the legacy sidelink SSB candidate slot in accordance with the first class of receiving UE having a first capability (e.g., low capability) and/or a first complexity (e.g., low complexity). In some aspects, a sidelink SSB from another sidelink SSB candidate slot being detected by the first class of receiving UE may result in a failure of a PSBCH descrambling operation. In some aspects, for example, in accordance with prior information of the sidelink SSB candidate locations and/or the sidelink SSB passing a PSBCH detection in the legacy sidelink SSB candidate slot, the first class of receiving UE may be configured to determine locations of the sidelink SSB slots and configure a resource pool (correctly) in an initial synchronization. A second class of receiving UE may be configured to monitor sidelink SSBs in a subset of sidelink SSB candidates. The subset of sidelink SSB candidates may be greater than one and may be less than a total number of sidelink SSB candidates. For example, the second class of receiving UE may be configured to monitor in the legacy sidelink SSB candidate slot and/or in one or more of (but less than all of) the additional sidelink SSB candidate slots. The second class of receiving UE may be configured to monitor sidelink SSBs in the subset of sidelink SSB candidates in accordance with the second class of receiving UE having a second capability (e.g., medium capability) and/or a second complexity (e.g., medium complexity). In one example, the second class of receiving UE may be configured to monitor in two or more sidelink SSB candidates that begins at the legacy sidelink SSB candidate slot. The second class of receiving UE may only need to perform a quantity of DMRS descrambling attempts (e.g., hypotheses) in accordance with a quantity of the subset of sidelink SSB candidate slots to be monitored. This may reduce a monitoring complexity. A third class of receiving UE may be configured to monitor sidelink SSBs in all sidelink SSB candidates. The third class of receiving UE may be configured to monitor sidelink SSBs in all sidelink SSB candidates in accordance with the third class of receiving UE having a third capability (e.g., high capability) and/or a third complexity (e.g., high complexity).

As shown by reference number 720, the receiving UE 610 may monitor a quantity of sidelink SSBs in accordance with the capability information. For example, the receiving UE 610 may monitor a sidelink SSB in a legacy sidelink SSB candidate in accordance with the receiving UE 610 being included in the first class of receiving UE. In another example, the receiving UE 610 may monitor a plurality of sidelink SSBs in the subset of sidelink SSB candidates in accordance with the receiving UE 610 being included in the second class of receiving UE. In another example, the receiving UE 610 may monitor a plurality of sidelink SSBs in all sidelink SSB candidates in accordance with the receiving UE 610 being included in the third class of receiving UE.

As indicated above, FIG. 7 is provided as an example. Other examples may differ from what is described with regard to FIG. 7.

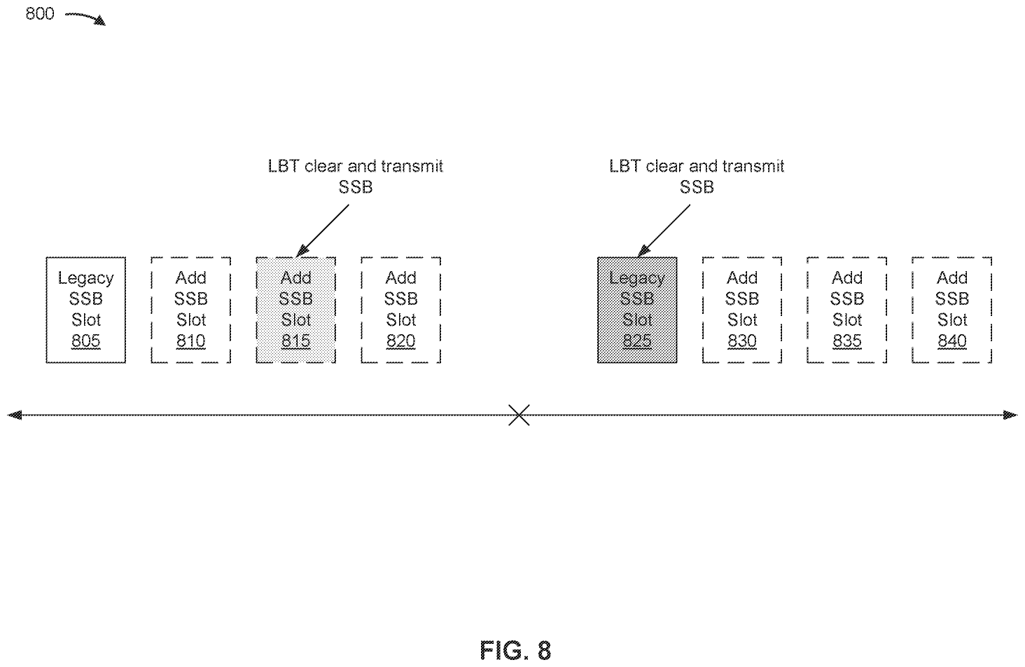

FIG. 8 is a diagram illustrating an example 800 of sidelink SSB candidates, in accordance with the present disclosure. A transmitting UE may be configured to transmit, and a receiving UE may be configured to receive, in one or more sidelink SSB slots (e.g., sidelink SSB candidates). For example, the transmitting UE may transmit, and the receiving UE may receive, in a first set of sidelink SSB slots associated with a first SSB transmission period and in a second set of sidelink SSB slots associated with a second SSB transmission period. The first set of sidelink SSB slots may include a legacy SSB slot 805 and one or more additional (shown as “add”) slots, such as add SSB slot 810, add SSB slot 815, and add SSB slot 820. The second set of sidelink SSB slots may include a legacy SSB slot 825 and one or more add slots, such as add SSB slot 830, add SSB slot 835, and add SSB slot 840. The legacy SSB slots may correspond to Release 16 or Release 17 sidelink SSB slots, while the add slots may correspond to Release 18 or Release 19 sidelink SSB slots. As shown in the figure, the transmitting UE may transmit, and the receiving UE may receive, a sidelink SSB in add SSB slot 815 in accordance with clearing an LBT. Additionally, or alternatively, the transmitting UE may transmit, and the receiving UE may receive, a sidelink SSB in legacy slot 825 in accordance with clearing an LBT.

In some aspects, in the first SSB period, the first class of transmitting UE may be configured to transmit in the legacy SSB slot 805 and the first class of receiving UE may be configured to monitor the legacy SSB slot 805. Additionally, in the second SSB period, the first class of transmitting UE may be configured to transmit in the legacy SSB slot 825 and the first class of receiving UE may be configured to monitor the legacy SSB slot 825. In some aspects, in the first SSB period, the second class of transmitting UE may be configured to transmit in the legacy SSB slot 805 and in one or more of (but less than all of) the add SSB slot 810, the add SSB 815, and the add SSB slot 820, and the second class of receiving UE may be configured to monitor the legacy SSB slot 805 and one or more of (but less than all of) the add SSB slot 810, the add SSB 815, and the add slot 820. Additionally, in the second SSB period, the second class of transmitting UE may be configured to transmit in the legacy SSB slot 825 and in one or more of (but less than all of) the add SSB slot 830, the add SSB 835, and the add SSB slot 840, and the second class of receiving UE may be configured to monitor the legacy SSB slot 825 and one or more of (but less than all of) the add SSB slot 830, the add SSB 835, and the add slot 840. In some aspects, in the first SSB period, the third class of transmitting UE may be configured to transmit in the legacy SSB slot 805, the add SSB slot 810, the add SSB 815, and the add SSB slot 820, and the third class of receiving UE may be configured to monitor the legacy SSB slot 805, the add SSB slot 810, the add SSB 815, and the add slot 820. Additionally, in the second SSB period, the third class of transmitting UE may be configured to transmit in the legacy SSB slot 825, the add SSB slot 830, the add SSB 835, and the add SSB slot 840, and the third class of receiving UE may be configured to monitor the legacy SSB slot 825, the add SSB slot 830, the add SSB 835, and the add slot 840.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with sidelink synchronization signal block communication.

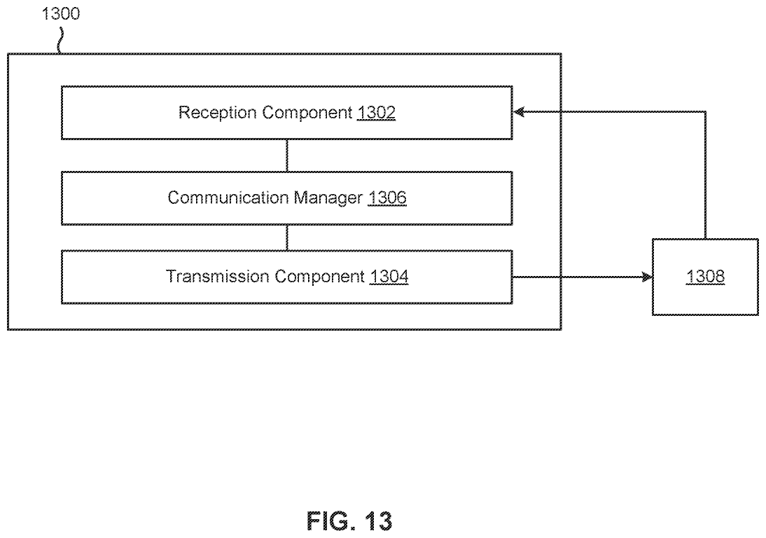

As shown in FIG. 9, in some aspects, process 900 may include obtaining an indication of a sidelink SSB candidate index associated with a sidelink SSB transmission (block 910). For example, the UE (e.g., using reception component 1302 and/or communication manager 1306, depicted in FIG. 13) may obtain an indication of a sidelink SSB candidate index associated with a sidelink SSB transmission, as described above.

As further shown in FIG. 9, in some aspects, process 900 may include transmitting, to a receiving UE, the indication of the sidelink SSB candidate index, the indication of the sidelink SSB candidate index being included in a sidelink SSB (block 920). For example, the UE (e.g., using transmission component 1304 and/or communication manager 1306, depicted in FIG. 13) may transmit, to a receiving UE, the indication of the sidelink SSB candidate index, the indication of the sidelink SSB candidate index being included in a sidelink SSB, as described above.

Process 900 may include additional aspects, such as any single aspect or any combination of aspects described below and/or in connection with one or more other processes described elsewhere herein.

In a first aspect, the sidelink SSB candidate index is associated with a sidelink SSB candidate slot.

In a second aspect, alone or in combination with the first aspect, transmitting the indication of the sidelink SSB candidate index comprises transmitting, via a physical sidelink broadcast channel demodulation reference signal scrambling sequence of the sidelink SSB, the indication of the sidelink SSB candidate index.

In a third aspect, alone or in combination with one or more of the first and second aspects, process 900 includes identifying, for a select sidelink SSB candidate index, an initial sidelink SSB candidate index based at least in part on a sidelink identification number.

In a fourth aspect, alone or in combination with one or more of the first through third aspects, process 900 includes identifying, for a select sidelink SSB candidate index having a value that is greater than zero, an initial sidelink SSB candidate index that is based at least in part on a sidelink identification number, or identifying, for a select sidelink SSB candidate index having a value that is equal to zero, an initial sidelink SSB candidate index that is equal to the sidelink identification number.

In a fifth aspect, alone or in combination with one or more of the first through fourth aspects, transmitting the indication of the sidelink SSB candidate index comprises transmitting, via a physical sidelink broadcast channel payload of the sidelink SSB, the indication of the sidelink SSB candidate index.

In a sixth aspect, alone or in combination with one or more of the first through fifth aspects, transmitting the indication of the sidelink SSB candidate index comprises transmitting at least a first portion of the sidelink SSB candidate index via a PSBCH DMRS scrambling sequence of the sidelink SSB and transmitting at least a second portion of the sidelink SSB candidate index via a PSBCH payload of the sidelink SSB.

In a seventh aspect, alone or in combination with one or more of the first through sixth aspects, the first portion of the sidelink SSB candidate index corresponds to a first portion of bits of a plurality of bits associated with the sidelink SSB candidate index, and the second portion of the sidelink SSB candidate index corresponds to one or more most significant bits included in a remainder of bits of the plurality of bits associated with the sidelink SSB candidate index.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with sidelink synchronization signal block communication.

As shown in FIG. 10, in some aspects, process 1000 may include receiving, from a transmitting UE, a sidelink SSB that includes an indication of a sidelink SSB candidate index (block 1010). For example, the UE (e.g., using reception component 1302 and/or communication manager 1306, depicted in FIG. 13) may receive, from a transmitting UE, a sidelink SSB that includes an indication of a sidelink SSB candidate index, as described above.

As further shown in FIG. 10, in some aspects, process 1000 may include decoding the sidelink SSB candidate index in accordance with receiving the sidelink SSB that includes the indication of the sidelink SSB candidate index (block 1020). For example, the UE (e.g., using communication manager 1306, depicted in FIG. 13) may decode the sidelink SSB candidate index in accordance with receiving the sidelink SSB that includes the indication of the sidelink SSB candidate index, as described above.

Process 1000 may include additional aspects, such as any single aspect or any combination of aspects described below and/or in connection with one or more other processes described elsewhere herein.

In a first aspect, decoding the sidelink SSB candidate index comprises identifying one or more sidelink SSB candidate slots in a time domain.

In a second aspect, alone or in combination with the first aspect, process 1000 includes configuring a resource pool that excludes the one or more sidelink SSB candidate slots.

In a third aspect, alone or in combination with one or more of the first and second aspects, process 1000 includes identifying, in accordance with decoding the sidelink SSB candidate index, a gap that is located between a first sidelink SSB candidate slot and a second sidelink SSB candidate slot, and an offset associated with a sidelink SSB period.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with sidelink synchronization signal block communication.

As shown in FIG. 11, in some aspects, process 1100 may include obtaining configuration information associated with sidelink SSB monitoring, the configuration information indicating a quantity of sidelink SSBs to be monitored by the receiving UE in accordance with a sidelink SSB monitoring capability of the receiving UE (block 1110). For example, the UE (e.g., using reception component 1302 and/or communication manager 1306, depicted in FIG. 13) may obtain configuration information associated with sidelink SSB monitoring, the configuration information indicating a quantity of sidelink SSBs to be monitored by the receiving UE in accordance with a sidelink SSB monitoring capability of the receiving UE, as described above.

As further shown in FIG. 11, in some aspects, process 1100 may include monitoring the quantity of sidelink SSBs in accordance with the configuration information and in accordance with the sidelink SSB monitoring capability of the receiving UE (block 1120). For example, the UE (e.g., using communication manager 1306, depicted in FIG. 13) may monitor the quantity of sidelink SSBs in accordance with the configuration information and in accordance with the sidelink SSB monitoring capability of the receiving UE, as described above.

Process 1100 may include additional aspects, such as any single aspect or any combination of aspects described below and/or in connection with one or more other processes described elsewhere herein.

In a first aspect, obtaining the configuration information that indicates the quantity of sidelink SSBs to be monitored by the receiving UE comprises obtaining configuration information that indicates for the receiving UE to monitor for a first quantity of sidelink SSBs in accordance with the receiving UE being a first type of receiving UE having a first sidelink SSB monitoring capability, a second quantity of sidelink SSBs in accordance with the receiving UE being a second type of receiving UE having a second sidelink SSB monitoring capability, the second quantity of sidelink SSBs being greater than the first quantity of sidelink SSBs, or a third quantity of sidelink SSBs in accordance with the receiving UE being a third type of receiving UE having a third sidelink SSB monitoring capability, the third quantity of sidelink SSBs being greater than the second quantity of sidelink SSBs.

In a second aspect, alone or in combination with the first aspect, the first quantity of sidelink SSBs corresponds to a single sidelink SSB that is located in a first sidelink SSB candidate slot, the second quantity of sidelink SSBs corresponds to a subset of sidelink SSBs having a quantity that is greater than one and that is less than a total quantity of sidelink SSB candidates, and the third quantity of sidelink SSBs corresponds to all sidelink SSBs included in the total quantity of sidelink SSB candidates.

In a third aspect, alone or in combination with one or more of the first and second aspects, monitoring the quantity of sidelink SSBs comprises monitoring, in accordance with the receiving UE being the first type of receiving UE having the first sidelink SSB monitoring capability, the single sidelink SSB in the first sidelink SSB candidate slot using a PSBCH scrambling sequence.

In a fourth aspect, alone or in combination with one or more of the first through third aspects, process 1100 includes identifying a PSBCH descrambling failure occurrence in accordance with the receiving UE detecting a sidelink SSB that does not correspond to the sidelink SSB in the first sidelink SSB candidate slot.

In a fifth aspect, alone or in combination with one or more of the first through fourth aspects, process 1100 includes identifying a location of the first sidelink SSB candidate slot, and configuring a resource pool in an initial synchronization, in accordance with a previous sidelink SSB candidate slot location.

In a sixth aspect, alone or in combination with one or more of the first through fifth aspects, monitoring the quantity of sidelink SSBs comprises monitoring, in accordance with the receiving UE being the second type of receiving UE having the second sidelink SSB monitoring capability, the subset of sidelink SSBs having the quantity that is greater than one and that is less than the total quantity of sidelink SSB candidates.

In a seventh aspect, alone or in combination with one or more of the first through sixth aspects, the subset of sidelink SSBs corresponds to a plurality of contiguous sidelink SSBs that begins at the first sidelink SSB candidate slot.

In an eighth aspect, alone or in combination with one or more of the first through seventh aspects, process 1100 includes performing a quantity of DMRS descrambling attempts, the quantity of DMRS descrambling attempts being equal to the quantity of sidelink SSBs included in the subset of sidelink SSBs to be monitored by the receiving UE.

In a ninth aspect, alone or in combination with one or more of the first through eighth aspects, monitoring the quantity of sidelink SSBs comprises monitoring, in accordance with the receiving UE being the third type of receiving UE having the third sidelink SSB monitoring capability, all sidelink SSBs included in the total quantity of sidelink SSB candidates.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with sidelink synchronization signal block communication.

As shown in FIG. 12, in some aspects, process 1200 may include obtaining configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE (block 1210). For example, the UE (e.g., using reception component 1302 and/or communication manager 1306, depicted in FIG. 13) may obtain configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE, as described above.

As further shown in FIG. 12, in some aspects, process 1200 may include transmitting a quantity of sidelink SSBs in the one or more sidelink SSB candidates in accordance with the configuration information and in accordance with the sidelink SSB transmission capability of the transmitting UE (block 1220). For example, the UE (e.g., using transmission component 1304 and/or communication manager 1306, depicted in FIG. 13) may transmit a quantity of sidelink SSBs in the one or more sidelink SSB candidates in accordance with the configuration information and in accordance with the sidelink SSB transmission capability of the transmitting UE, as described above.

Process 1200 may include additional aspects, such as any single aspect or any combination of aspects described below and/or in connection with one or more other processes described elsewhere herein.

In a first aspect, obtaining the configuration information that indicates the one or more sidelink SSB candidates to be used by the transmitting UE for transmitting sidelink SSBs comprises obtaining configuration information that indicates for the transmitting UE to transmit one or more sidelink SSBs in a first quantity of sidelink SSB candidates in accordance with the transmitting UE being a first type of transmitting UE having a first sidelink SSB transmission capability, one or more sidelink SSBs in a second quantity of sidelink SSB candidates in accordance with the transmitting UE being a second type of transmitting UE having a second sidelink SSB transmission capability, the second quantity of sidelink SSB candidates being greater than the first quantity of sidelink SSB candidates, or one or more sidelink SSB in a third quantity of sidelink SSB candidates in accordance with the transmitting UE being a third type of transmitting UE having a third sidelink SSB transmission capability, the third quantity of sidelink SSB candidates being greater than the second quantity of sidelink SSB candidates.

In a second aspect, alone or in combination with the first aspect, the first quantity of sidelink SSB candidates corresponds to a single sidelink SSB candidate that is located in a first sidelink SSB candidate slot, the second quantity of sidelink SSB candidates corresponds to a subset of sidelink SSB candidates having a quantity that is greater than one and that is less than a total quantity of candidate sidelink SSB candidates, and the third quantity of sidelink SSB candidates corresponds to all sidelink SSB candidates included in the total quantity of sidelink SSB candidates.

In a third aspect, alone or in combination with one or more of the first and second aspects, transmitting the quantity of sidelink SSBs comprises transmitting, in accordance with the transmitting UE being the first type of transmitting UE having the first sidelink SSB transmission capability, a single sidelink SSB in the first sidelink SSB candidate slot.

In a fourth aspect, alone or in combination with one or more of the first through third aspects, process 1200 includes skipping one or more remaining sidelink SSB candidate slots that are located after the first sidelink SSB candidate slot, the first sidelink SSB candidate slot and the one or more remaining sidelink SSB candidate slots being associated with a first sidelink SSB transmission period, and transmitting a sidelink SSB in a first sidelink SSB candidate slot associated with a second sidelink SSB transmission period.

In a fifth aspect, alone or in combination with one or more of the first through fourth aspects, transmitting the quantity of sidelink SSBs comprises transmitting, in accordance with the transmitting UE being the second type of transmitting UE having the second sidelink SSB transmission capability, a subset of sidelink SSBs in the subset of sidelink SSB candidates.

In a sixth aspect, alone or in combination with one or more of the first through fifth aspects, the subset of sidelink SSB candidates corresponds to a plurality of contiguous sidelink SSB candidates that begins at the first sidelink SSB candidate slot.

In a seventh aspect, alone or in combination with one or more of the first through sixth aspects, transmitting the quantity of sidelink SSBs comprises transmitting, in accordance with the transmitting UE being the third type of transmitting UE having the third sidelink SSB transmission capability, sidelink SSBs in all sidelink SSB candidates included in the total quantity of sidelink SSB candidates.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-8. Additionally, or alternatively, the apparatus 1300 may be configured to perform one or more processes described herein, such as process 900 of FIG. 9, process 1000 of FIG. 10, process 1100 of FIG. 11, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may obtain an indication of a sidelink SSB candidate index associated with a sidelink SSB transmission. The transmission component 1304 may transmit, to a receiving UE, the indication of the sidelink SSB candidate index, the indication of the sidelink SSB candidate index being included in a sidelink SSB. The communication manager 1306 may identify, for a select sidelink SSB candidate index, an initial sidelink SSB candidate index based at least in part on a sidelink identification number. The communication manager 1306 may identify, for a select sidelink SSB candidate index having a value that is greater than zero, an initial sidelink SSB candidate index that is based at least in part on a sidelink identification number. The communication manager 1306 may identify, for a select sidelink SSB candidate index having a value that is equal to zero, an initial sidelink SSB candidate index that is equal to the sidelink identification number.

The reception component 1302 may receive, from a transmitting UE, a sidelink SSB that includes an indication of a sidelink SSB candidate index. The communication manager 1306 may decode the sidelink SSB candidate index in accordance with receiving the sidelink SSB that includes the indication of the sidelink SSB candidate index. The communication manager 1306 may configure a resource pool that excludes the one or more sidelink SSB candidate slots. The communication manager 1306 may identify, in accordance with decoding the sidelink SSB candidate index, a gap that is located between a first sidelink SSB candidate slot and a second sidelink SSB candidate slot, and an offset associated with a sidelink SSB period.

The reception component 1302 may obtain configuration information associated with sidelink SSB monitoring, the configuration information indicating a quantity of sidelink SSBs to be monitored by the receiving UE in accordance with a sidelink SSB monitoring capability of the receiving UE. The communication manager 1306 may monitor the quantity of sidelink SSBs in accordance with the configuration information and in accordance with the sidelink SSB monitoring capability of the receiving UE. The communication manager 1306 may identify a PSBCH descrambling failure occurrence in accordance with the receiving UE detecting a sidelink SSB that does not correspond to the sidelink SSB in the first sidelink SSB candidate slot. The communication manager 1306 may identify a location of the first sidelink SSB candidate slot, and configure a resource pool in an initial synchronization, in accordance with a previous sidelink SSB candidate slot location. The communication manager 1306 may perform a quantity of DMRS descrambling attempts, the quantity of DMRS descrambling attempts being equal to the quantity of sidelink SSBs included in the subset of sidelink SSBs to be monitored by the receiving UE.

The reception component 1302 may obtain configuration information associated with a sidelink SSB transmission, the configuration information indicating one or more sidelink SSB candidates to be used by the transmitting UE for transmitting sidelink SSBs in accordance with a sidelink SSB transmission capability of the transmitting UE. The transmission component 1304 may transmit a quantity of sidelink SSBs in the one or more sidelink SSB candidates in accordance with the configuration information and in accordance with the sidelink SSB transmission capability of the transmitting UE. The communication manager 1306 may skip one or more remaining sidelink SSB candidate slots that are located after the first sidelink SSB candidate slot, the first sidelink SSB candidate slot and the one or more remaining sidelink SSB candidate slots being associated with a first sidelink SSB transmission period. The transmission component 1304 may transmit a sidelink SSB in a first sidelink SSB candidate slot associated with a second sidelink SSB transmission period.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a transmitting user equipment (UE), comprising: obtaining an indication of a sidelink synchronization signal block (SSB) candidate index associated with a sidelink SSB transmission; and transmitting, to a receiving UE, the indication of the sidelink SSB candidate index, the indication of the sidelink SSB candidate index being included in a sidelink SSB.
Aspect 2: The method of Aspect 1, wherein the sidelink SSB candidate index is associated with a sidelink SSB candidate slot.
Aspect 3: The method of any of Aspects 1-2, wherein transmitting the indication of the sidelink SSB candidate index comprises transmitting, via a physical sidelink broadcast channel demodulation reference signal scrambling sequence of the sidelink SSB, the indication of the sidelink SSB candidate index.
Aspect 4: The method of Aspect 3, further comprising identifying, for a select sidelink SSB candidate index, an initial sidelink SSB candidate index based at least in part on a sidelink identification number.
Aspect 5: The method of Aspect 3, further comprising: identifying, for a select sidelink SSB candidate index having a value that is greater than zero, an initial sidelink SSB candidate index that is based at least in part on a sidelink identification number; or identifying, for a select sidelink SSB candidate index having a value that is equal to zero, an initial sidelink SSB candidate index that is equal to the sidelink identification number.
Aspect 6: The method of any of Aspects 1-5, wherein transmitting the indication of the sidelink SSB candidate index comprises transmitting, via a physical sidelink broadcast channel payload of the sidelink SSB, the indication of the sidelink SSB candidate index.
Aspect 7: The method of any of Aspects 1-6, wherein transmitting the indication of the sidelink SSB candidate index comprises transmitting at least a first portion of the sidelink SSB candidate index via a physical sidelink broadcast channel (PSBCH) demodulation reference signal (DMRS) scrambling sequence of the sidelink SSB and transmitting at least a second portion of the sidelink SSB candidate index via a PSBCH payload of the sidelink SSB.
Aspect 8: The method of Aspect 7, wherein the first portion of the sidelink SSB candidate index corresponds to a first portion of bits of a plurality of bits associated with the sidelink SSB candidate index, and the second portion of the sidelink SSB candidate index corresponds to one or more most significant bits included in a remainder of bits of the plurality of bits associated with the sidelink SSB candidate index.
Aspect 9: A method of wireless communication performed by a receiving user equipment (UE), comprising: receiving, from a transmitting UE, a sidelink synchronization signal block (SSB) that includes an indication of a sidelink SSB candidate index; and decoding the sidelink SSB candidate index in accordance with receiving the sidelink SSB that includes the indication of the sidelink SSB candidate index.
Aspect 10: The method of Aspect 9, wherein decoding the sidelink SSB candidate index comprises identifying one or more sidelink SSB candidate slots in a time domain.
Aspect 11: The method of Aspect 10, further comprising configuring a resource pool that excludes the one or more sidelink SSB candidate slots.
Aspect 12: The method of Aspect 11, further comprising identifying, in accordance with decoding the sidelink SSB candidate index, a gap that is located between a first sidelink SSB candidate slot and a second sidelink SSB candidate slot, and an offset associated with a sidelink SSB period.
Aspect 13: A method of wireless communication performed by a receiving user equipment (UE), comprising: obtaining configuration information associated with sidelink synchronization signal block (SSB) monitoring, the configuration information indicating a quantity of sidelink SSBs to be monitored by the receiving UE in accordance with a sidelink SSB monitoring capability of the receiving UE; and monitoring the quantity of sidelink SSBs in accordance with the configuration information and in accordance with the sidelink SSB monitoring capability of the receiving UE.
Aspect 14: The method of Aspect 13, wherein obtaining the configuration information that indicates the quantity of sidelink SSBs to be monitored by the receiving UE comprises obtaining configuration information that indicates for the receiving UE to monitor for a first quantity of sidelink SSBs in accordance with the receiving UE being a first type of receiving UE having a first sidelink SSB monitoring capability, a second quantity of sidelink SSBs in accordance with the receiving UE being a second type of receiving UE having a second sidelink SSB monitoring capability, the second quantity of sidelink SSBs being greater than the first quantity of sidelink SSBs, or a third quantity of sidelink SSBs in accordance with the receiving UE being a third type of receiving UE having a third sidelink SSB monitoring capability, the third quantity of sidelink SSBs being greater than the second quantity of sidelink SSBs.
Aspect 15: The method of Aspect 14, wherein the first quantity of sidelink SSBs corresponds to a single sidelink SSB that is located in a first sidelink SSB candidate slot, the second quantity of sidelink SSBs corresponds to a subset of sidelink SSBs having a quantity that is greater than one and that is less than a total quantity of sidelink SSB candidates, and the third quantity of sidelink SSBs corresponds to all sidelink SSBs included in the total quantity of sidelink SSB candidates.
Aspect 16: The method of Aspect 15, wherein monitoring the quantity of sidelink SSBs comprises monitoring, in accordance with the receiving UE being the first type of receiving UE having the first sidelink SSB monitoring capability, the single sidelink SSB in the first sidelink SSB candidate slot using a physical sidelink broadcast channel (PSBCH) scrambling sequence.
Aspect 17: The method of Aspect 16, further comprising identifying a PSBCH descrambling failure occurrence in accordance with the receiving UE detecting a sidelink SSB that does not correspond to the sidelink SSB in the first sidelink SSB candidate slot.
Aspect 18: The method of Aspect 16, further comprising identifying a location of the first sidelink SSB candidate slot, and configuring a resource pool in an initial synchronization, in accordance with a previous sidelink SSB candidate slot location.
Aspect 19: The method of Aspect 15, wherein monitoring the quantity of sidelink SSBs comprises monitoring, in accordance with the receiving UE being the second type of receiving UE having the second sidelink SSB monitoring capability, the subset of sidelink SSBs having the quantity that is greater than one and that is less than the total quantity of sidelink SSB candidates.
Aspect 20: The method of Aspect 19, wherein the subset of sidelink SSBs corresponds to a plurality of contiguous sidelink SSBs that begins at the first sidelink SSB candidate slot.
Aspect 21: The method of Aspect 19, further comprising performing a quantity of demodulation reference signal (DMRS) descrambling attempts, the quantity of DMRS descrambling attempts being equal to the quantity of sidelink SSBs included in the subset of sidelink SSBs to be monitored by the receiving UE.
Aspect 22: The method of Aspect 15, wherein monitoring the quantity of sidelink SSBs comprises monitoring, in accordance with the receiving UE being the third type of receiving UE having the third sidelink SSB monitoring capability, all sidelink SSBs included in the total quantity of sidelink SSB candidates.
Aspect 23: A method of wireless communication performed by a transmitting user equipment (UE), comprising: obtaining configuration information associated with a sidelink synchronization signal block (SSB) transmission, the configuration information indicating one or more sidelink SSB candidates to be used by the transmitting UE for transmitting sidelink SSBs in accordance with a sidelink SSB transmission capability of the transmitting UE; and transmitting a quantity of sidelink SSBs in the one or more sidelink SSB candidates in accordance with the configuration information and in accordance with the sidelink SSB transmission capability of the transmitting UE.
Aspect 24: The method of Aspect 23, wherein obtaining the configuration information that indicates the one or more sidelink SSB candidates to be used by the transmitting UE for transmitting sidelink SSBs comprises obtaining configuration information that indicates for the transmitting UE to transmit one or more sidelink SSBs in a first quantity of sidelink SSB candidates in accordance with the transmitting UE being a first type of transmitting UE having a first sidelink SSB transmission capability, one or more sidelink SSBs in a second quantity of sidelink SSB candidates in accordance with the transmitting UE being a second type of transmitting UE having a second sidelink SSB transmission capability, the second quantity of sidelink SSB candidates being greater than the first quantity of sidelink SSB candidates, or one or more sidelink SSB in a third quantity of sidelink SSB candidates in accordance with the transmitting UE being a third type of transmitting UE having a third sidelink SSB transmission capability, the third quantity of sidelink SSB candidates being greater than the second quantity of sidelink SSB candidates.
Aspect 25: The method of Aspect 24, wherein the first quantity of sidelink SSB candidates corresponds to a single sidelink SSB candidate that is located in a first sidelink SSB candidate slot, the second quantity of sidelink SSB candidates corresponds to a subset of sidelink SSB candidates having a quantity that is greater than one and that is less than a total quantity of candidate sidelink SSB candidates, and the third quantity of sidelink SSB candidates corresponds to all sidelink SSB candidates included in the total quantity of sidelink SSB candidates.
Aspect 26: The method of Aspect 25, wherein transmitting the quantity of sidelink SSBs comprises transmitting, in accordance with the transmitting UE being the first type of transmitting UE having the first sidelink SSB transmission capability, a single sidelink SSB in the first sidelink SSB candidate slot.
Aspect 27: The method of Aspect 26, further comprising, in accordance with detecting a listen-before-talk failure: skipping one or more remaining sidelink SSB candidate slots that are located after the first sidelink SSB candidate slot, the first sidelink SSB candidate slot and the one or more remaining sidelink SSB candidate slots being associated with a first sidelink SSB transmission period; and transmitting a sidelink SSB in a first sidelink SSB candidate slot associated with a second sidelink SSB transmission period.
Aspect 28: The method of Aspect 25, wherein transmitting the quantity of sidelink SSBs comprises transmitting, in accordance with the transmitting UE being the second type of transmitting UE having the second sidelink SSB transmission capability, a subset of sidelink SSBs in the subset of sidelink SSB candidates.
Aspect 29: The method of Aspect 28, wherein the subset of sidelink SSB candidates corresponds to a plurality of contiguous sidelink SSB candidates that begins at the first sidelink SSB candidate slot.
Aspect 30: The method of Aspect 25, wherein transmitting the quantity of sidelink SSBs comprises transmitting, in accordance with the transmitting UE being the third type of transmitting UE having the third sidelink SSB transmission capability, sidelink SSBs in all sidelink SSB candidates included in the total quantity of sidelink SSB candidates.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting user equipment (UE) for wireless communication, comprising:
one or more memories; and
one or more processors, coupled to the one or more memories, configured to:
obtain an indication of a sidelink synchronization signal block (SSB) candidate index associated with a sidelink SSB transmission; and
transmit, to a receiving UE, the indication of the sidelink SSB candidate index, the indication of the sidelink SSB candidate index being included in a sidelink SSB.

2. The transmitting UE of claim 1, wherein the sidelink SSB candidate index is associated with a sidelink SSB candidate slot.

3. The transmitting UE of claim 1, wherein the one or more processors, to transmit the indication of the sidelink SSB candidate index, are configured to transmit, via a physical sidelink broadcast channel demodulation reference signal scrambling sequence of the sidelink SSB, the indication of the sidelink SSB candidate index.

4. The transmitting UE of claim 3, wherein the one or more processors are further configured to identify, for a select sidelink SSB candidate index, an initial sidelink SSB candidate index based at least in part on a sidelink identification number.

5. The transmitting UE of claim 3, wherein the one or more processors are further configured to:
identify, for a select sidelink SSB candidate index having a value that is greater than zero, an initial sidelink SSB candidate index that is based at least in part on a sidelink identification number; or
identify, for a select sidelink SSB candidate index having a value that is equal to zero, an initial sidelink SSB candidate index that is equal to the sidelink identification number.

6. The transmitting UE of claim 1, wherein the one or more processors, to transmit the indication of the sidelink SSB candidate index, are configured to transmit, via a physical sidelink broadcast channel payload of the sidelink SSB, the indication of the sidelink SSB candidate index.

7. The transmitting UE of claim 1, wherein the one or more processors, to transmit the indication of the sidelink SSB candidate index, are configured to transmit at least a first portion of the sidelink SSB candidate index via a physical sidelink broadcast channel (PSBCH) demodulation reference signal (DMRS) scrambling sequence of the sidelink SSB and transmit at least a second portion of the sidelink SSB candidate index via a PSBCH payload of the sidelink SSB.

8. The transmitting UE of claim 7, wherein the first portion of the sidelink SSB candidate index corresponds to a first portion of bits of a plurality of bits associated with the sidelink SSB candidate index, and the second portion of the sidelink SSB candidate index corresponds to one or more most significant bits included in a remainder of bits of the plurality of bits associated with the sidelink SSB candidate index.

9. A receiving user equipment (UE) for wireless communication, comprising:
one or more memories; and
one or more processors, coupled to the one or more memories, configured to:
receive, from a transmitting UE, a sidelink synchronization signal block (SSB) that includes an indication of a sidelink SSB candidate index; and
decode the sidelink SSB candidate index in accordance with receiving the sidelink SSB that includes the indication of the sidelink SSB candidate index.

10. The receiving UE of claim 9, wherein the one or more processors, to decode the sidelink SSB candidate index, are configured to identify one or more sidelink SSB candidate slots in a time domain.

11. The receiving UE of claim 10, wherein the one or more processors are further configured to configure a resource pool that excludes the one or more sidelink SSB candidate slots.

12. The receiving UE of claim 11, wherein the one or more processors are further configured to identify, in accordance with decoding the sidelink SSB candidate index, a gap that is located between a first sidelink SSB candidate slot and a second sidelink SSB candidate slot, and an offset associated with a sidelink SSB period.

13. A receiving user equipment (UE) for wireless communication, comprising:
one or more memories; and
one or more processors, coupled to the one or more memories, configured to:
obtain configuration information associated with sidelink synchronization signal block (SSB) monitoring, the configuration information indicating a quantity of sidelink SSBs to be monitored by the receiving UE in accordance with a sidelink SSB monitoring capability of the receiving UE; and
monitor the quantity of sidelink SSBs in accordance with the configuration information and in accordance with the sidelink SSB monitoring capability of the receiving UE.

14. The receiving UE of claim 13, wherein the one or more processors, to obtain the configuration information that indicates the quantity of sidelink SSBs to be monitored by the receiving UE, are configured to obtain configuration information that indicates for the receiving UE to monitor for a first quantity of sidelink SSBs in accordance with the receiving UE being a first type of receiving UE having a first sidelink SSB monitoring capability, a second quantity of sidelink SSBs in accordance with the receiving UE being a second type of receiving UE having a second sidelink SSB monitoring capability, the second quantity of sidelink SSBs being greater than the first quantity of sidelink SSBs, or a third quantity of sidelink SSBs in accordance with the receiving UE being a third type of receiving UE having a third sidelink SSB monitoring capability, the third quantity of sidelink SSBs being greater than the second quantity of sidelink SSBs.

15. The receiving UE of claim 14, wherein the first quantity of sidelink SSBs corresponds to a single sidelink SSB that is located in a first sidelink SSB candidate slot, the second quantity of sidelink SSBs corresponds to a subset of sidelink SSBs having a quantity that is greater than one and that is less than a total quantity of sidelink SSB candidates, and the third quantity of sidelink SSBs corresponds to all sidelink SSBs included in the total quantity of sidelink SSB candidates.

16. The receiving UE of claim 15, wherein the one or more processors, to monitor the quantity of sidelink SSBs, are configured to monitor, in accordance with the receiving UE being the first type of receiving UE having the first sidelink SSB monitoring capability, the single sidelink SSB in the first sidelink SSB candidate slot using a physical sidelink broadcast channel (PSBCH) scrambling sequence.

17. The receiving UE of claim 16, wherein the one or more processors are further configured to identify a PSBCH descrambling failure occurrence in accordance with the receiving UE detecting a sidelink SSB that does not correspond to the sidelink SSB in the first sidelink SSB candidate slot.

18. The receiving UE of claim 16, wherein the one or more processors are further configured to identify a location of the first sidelink SSB candidate slot, and configure a resource pool in an initial synchronization, in accordance with a previous sidelink SSB candidate slot location.

19. The receiving UE of claim 15, wherein the one or more processors, to monitor the quantity of sidelink SSBs, are configured to monitor, in accordance with the receiving UE being the second type of receiving UE having the second sidelink SSB monitoring capability, the subset of sidelink SSBs having the quantity that is greater than one and that is less than the total quantity of sidelink SSB candidates.

20. The receiving UE of claim 19, wherein the subset of sidelink SSBs corresponds to a plurality of contiguous sidelink SSBs that begins at the first sidelink SSB candidate slot.

21. The receiving UE of claim 19, wherein the one or more processors are further configured to perform a quantity of demodulation reference signal (DMRS) descrambling attempts, the quantity of DMRS descrambling attempts being equal to the quantity of sidelink SSBs included in the subset of sidelink SSBs to be monitored by the receiving UE.

22. The receiving UE of claim 15, wherein the one or more processors, to monitor the quantity of sidelink SSBs, are configured to monitor, in accordance with the receiving UE being the third type of receiving UE having the third sidelink SSB monitoring capability, all sidelink SSBs included in the total quantity of sidelink SSB candidates.

23. A transmitting user equipment (UE) for wireless communication, comprising:
one or more memories; and
one or more processors, coupled to the one or more memories, configured to:
obtain configuration information associated with a sidelink synchronization signal block (SSB) transmission, the configuration information indicating one or more sidelink SSB candidates to be used by the transmitting UE for transmitting sidelink SSBs in accordance with a sidelink SSB transmission capability of the transmitting UE; and
transmit a quantity of sidelink SSBs in the one or more sidelink SSB candidates in accordance with the configuration information and in accordance with the sidelink SSB transmission capability of the transmitting UE.

24. The transmitting UE of claim 23, wherein the one or more processors, to obtain the configuration information that indicates the one or more sidelink SSB candidates to be used by the transmitting UE for transmitting sidelink SSBs, are configured to obtain configuration information that indicates for the transmitting UE to transmit one or more sidelink SSBs in a first quantity of sidelink SSB candidates in accordance with the transmitting UE being a first type of transmitting UE having a first sidelink SSB transmission capability, one or more sidelink SSBs in a second quantity of sidelink SSB candidates in accordance with the transmitting UE being a second type of transmitting UE having a second sidelink SSB transmission capability, the second quantity of sidelink SSB candidates being greater than the first quantity of sidelink SSB candidates, or one or more sidelink SSB in a third quantity of sidelink SSB candidates in accordance with the transmitting UE being a third type of transmitting UE having a third sidelink SSB transmission capability, the third quantity of sidelink SSB candidates being greater than the second quantity of sidelink SSB candidates.

25. The transmitting UE of claim 24, wherein the first quantity of sidelink SSB candidates corresponds to a single sidelink SSB candidate that is located in a first sidelink SSB candidate slot, the second quantity of sidelink SSB candidates corresponds to a subset of sidelink SSB candidates having a quantity that is greater than one and that is less than a total quantity of candidate sidelink SSB candidates, and the third quantity of sidelink SSB candidates corresponds to all sidelink SSB candidates included in the total quantity of sidelink SSB candidates.

26. The transmitting UE of claim 25, wherein the one or more processors, to transmit the quantity of sidelink SSBs, are configured to transmit, in accordance with the transmitting UE being the first type of transmitting UE having the first sidelink SSB transmission capability, a single sidelink SSB in the first sidelink SSB candidate slot.

27. The transmitting UE of claim 26, wherein the one or more processors are further configured to, in accordance with detecting a listen-before-talk failure:
skip one or more remaining sidelink SSB candidate slots that are located after the first sidelink SSB candidate slot, the first sidelink SSB candidate slot and the one or more remaining sidelink SSB candidate slots being associated with a first sidelink SSB transmission period; and
transmit a sidelink SSB in a first sidelink SSB candidate slot associated with a second sidelink SSB transmission period.

28. The transmitting UE of claim 25, wherein the one or more processors, to transmit the quantity of sidelink SSBs, are configured to transmit, in accordance with the transmitting UE being the second type of transmitting UE having the second sidelink SSB transmission capability, a subset of sidelink SSBs in the subset of sidelink SSB candidates.

29. The transmitting UE of claim 28, wherein the subset of sidelink SSB candidates corresponds to a plurality of contiguous sidelink SSB candidates that begins at the first sidelink SSB candidate slot.

30. The transmitting UE of claim 25, wherein the one or more processors, to transmit the quantity of sidelink SSBs, are configured to transmit, in accordance with the transmitting UE being the third type of transmitting UE having the third sidelink SSB transmission capability, sidelink SSBs in all sidelink SSB candidates included in the total quantity of sidelink SSB candidates.
